(19) United States
(12) Patent Application Publication
(10) Pub. No.: US 2022/0132956 A1
(43) Pub. Date: May 5, 2022

(54) GARMENT WITH DIRECTIONAL INDICIA FOR VISUALIZING AND REMEMBERING A COORDINATED MOVEMENT OF BODY SEGMENTS

(71) Applicant: David Aaron Schwartz, East Hampton, NY (US)

(72) Inventor: David Aaron Schwartz, East Hampton, NY (US)

(21) Appl. No.: 17/089,996

(22) Filed: Nov. 5, 2020

(51) Int. Cl. A41D 27/08

(52) U.S. Cl. CPC A41D 27/08; A41D 2600/10

(57) ABSTRACT

The present invention is directed to a garment for assisting a user to instantaneously visualize and remember a coordinated movement of body segments at the moment before and/or during the task. The coordinated movement can be related to any physical task such as sports, therapy, aerobics, dance, etc. The garment according to the present invention comprises an arrangement of arrows in or on a fabric of the garment, wherein the position of the arrows relative to body segments and the direction of the arrows indicates the direction in which the related body segment should be moved and/or aligned.

### FIELD OF INVENTION

The present invention relates to a garment, and particularly, relates to a garment incorporating directional indicia.

### BACKGROUND

Humans rely on motion skills to perform day to day activities as well as complex activities. These activities include playing sports, exercising, dance, etc. Knowing how to do things, also known as motor skills, are stored in a special memory in the human brain known as procedural memory. This is an unconscious memory of skills which aids the performance of particular types of tasks, particularly the use of objects or movements of the body.

The procedural memory is usually acquired by the repetitive performance of a task. For example, swimming is learned by first observing and then consciously practicing the moves. The first step is to know how to do a task, for example through demonstration, illustrations, or video. Thereafter, performing the task and correcting any error. The skills are learned through the conscious performance of the task several times, till the know-how to do the task is captured in the procedural memory. However, to learn the task, a person may require the assistance of a second person who can observe the learner performing the task and instruct the correct way. For example, in body training and sports, instructors and coaches help to learn correct body movements.

However, building the procedural memory for a specific task is a time-taking process. For complex tasks, the time to learn the task can be significantly more. Also, depending upon the capability of a human, it may not be possible to perform a complex task unconsciously. Other factors that affect human memory can also make it difficult to learn or unconsciously perform a complex task. Also, a coach or instructor may not always be present to guide.

Thus, a long-term need is there for a system that can assist a user in performing and learning a task.

The term “task” hereinafter connotes a physical activity involving movements of body segments, and in more particular connotes one or more steps of a physical activity involving a coordinated movement of body segments. Examples of the task can include swinging a golf club, making a tennis stroke, shooting a basketball, throwing a bowling ball, lifting a weight, a dance routine, or any other specific physical exercise or activity.

### SUMMARY OF THE INVENTION

One object of the present invention is therefore directed to a garment with directional indicia that can assist a user in performing and learning a complex task or activity.

It is an additional object of the present invention that the garment can provide a directional instruction for a coordinated movement of body segments for performing a task.

It is still an additional object of the present invention that the garment can be adapted for different tasks.

It is yet an additional object of the present invention that the garment helps a user to remember a coordinated movement of body segments.

It is an additional object of the present invention that the garment helps a user align body segments toward a target in relation to performing a task.

It is another object of the present invention that the garment allows a user to build procedural memory for performing a task.

It is still another object of the present invention that the garment is economical to manufacture and easy to use.

It is yet another object of the present invention that the garment serves as a functional reminder to where certain body segments should be or need to be moved while performing a task.

It is a further object of the present invention that the garment may help a user to recall certain steps or movements of a complex physical activity.

It is still a further object of the present invention that the garment helps a user to visualize a coordinated movement of body segments and or feel what body segments should be moving.

It is yet another object of the present invention that the garment assists a user in performing and remembering one or more steps of physical activity such as sports, fitness, training, dance, and physical therapy.

It is a further object of the present invention that the user may adjust the directional indicia.

In one aspect, the present invention is directed to a garment having directional indicia. The garment can be underwear or outerwear made from fabric. Furthermore, the garment can be an upper garment, a lower garment, or a full-body garment. The garment can include all types of wears including sports wears, such as short and long sleeve shirts, long and short pants, arm sleeves, and leg sleeves. The upper garment can be including a torso portion, an upper left limb portion, and an upper right limb portion. The lower garment can include a lower left limb portion and a lower right limb portion. The garment can further include footwear, socks, headgear, gloves, fingerless gloves, mittens, neckwear, wrist bands, armbands, knee bands, and leg bands.

In one aspect, the directional indicia can be an indicia that points in a specific direction and includes a single-headed arrow and a double-headed arrow. The directional indicia can also include a series or combination of triangles, circles, squares, pointers, lines, and other shapes pointing in a combination of directions or marking a spot on the body depending on the desired movement or alignment. The directional indicia may be labeled with a number either on or near the directional indicia to indicate the order of sequence. Moreover, one or more directional indicia may incorporate a textured backing under the fabric to be felt on the skin of the user. A user can feel the texture of the material under the indicia touching the skin and by the sense of the texture, gets the direction in which the indicia points.

In one aspect, one or more arrows can be incorporated on a garment relative to the body segments, such as one or more arrows pointing in a direction in which the related body segments should move and in the order they should move and/or be aligned. The arrow or shape can be straight or curved, wherein an angle can define the degree of curve. The degree of curve of the arrows or shape can indicate the type of movement for the body segment, such as the rotational movement of the body segment.

In one aspect, the position of arrows, type of arrows including the single-headed and the double-headed, direction of the arrows, and the degree of curve of the arrows can be configured according to a task. The arrows can be used for one single direction or a combination of directions. Other shapes may be incorporated with or without the arrows to indicate a certain required position or alignment of the body segments.

In one aspect, the direction indicia or arrows can be removably coupled to the garment. The arrows can be sewn, patched, applied with a hook and loop fastener, magnetized, or part of the pattern of the fabric itself. When not part of the fabric of the garment, the arrows can be made of any material and attached in any manner. The arrows can be provided with a textured material under the fabric that can be felt by the skin of the user of the garment. The fabric under the fabric and below the arrows can have a textured surface to provide a tactile feel against the skin as an enhanced reminder of the direction desired. The arrows on the fabric indicate the direction the relevant body segments should be moving to help users remember the desired motion and or alignment by instantaneously visualizing and feeling the arrows or other directional indicia to aid in building motor memory.

In one aspect, the user can choose the positions of the directional indicia on the garment to suit their specific needs.

These and other objects and advantages of the embodiments herein will become readily apparent from the following detailed description taken in conjunction with the accompanying drawings

### BRIEF DESCRIPTION OF THE DRAWINGS

FIG. 1 is a front view of an upper garment showing the torso portion, upper left limb portion, and the upper right limb portion, according to an embodiment of the present invention.

FIG. 2 is a rear view of the upper garment of FIG. 1, according to an embodiment of the present invention.

FIG. 3 is a left-side view of the upper garment of FIG. 1, according to an embodiment of the present invention.

FIG. 4 is a right-side view of the upper garment of FIG. 1, according to an embodiment of the present invention.

FIG. 5 is a front view of a lower garment, according to an embodiment of the present invention.

FIG. 6 is a side view of the lower garment of FIG. 5, according to an embodiment of the present invention.

FIG. 7 is a front view of a left-hand glove, according to an embodiment of the present invention.

FIG. 8 is a flow chart showing a method of incorporating directional indicia on a garment, according to an embodiment of the present invention.

FIG. 9 is a flow chart showing another implementation of the method, according to an embodiment of the present invention.

FIG. 10 is a flow chart showing another implementation of the method, according to an embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention as there are numerous combinations. The description is not to be taken in a limiting sense but is made merely to illustrate the general principles of the alternative embodiments of the invention, since the scope of the alternative embodiments of the invention will be best defined by the allowed claims of any resulting patent.

The present invention is directed to a garment, having directional indicia, for humans and includes hand wear and footwear. The garment according to the present invention can be manufactured for both male and female. Moreover, the garment can be manufactured for children and adults. The garment can also be manufactured in assorted sizes or can also be custom made for a user. Furthermore, the garment can be of various types, including ordinary wear and specialized wear. Ordinary wear garments can be worn during the day to day activities. On the other hand, the specialized garments can be suited for a specific task, such as a swimming suit, sports uniform, under padding, golf apparel, tennis apparel, a cricket suit, and like. Also, the garment according to the present invention can be manufactured using a fabric, such as cotton, nylon, spandex, or any other known material for the manufacture of garment and includes a combination of such known materials. The garment according to the present invention can also be manufactured with different textured materials under the fabric as to be felt by the user. The garment according to the present invention can be for sports, training, exercise, aerobics, dance, and similar physical activities.

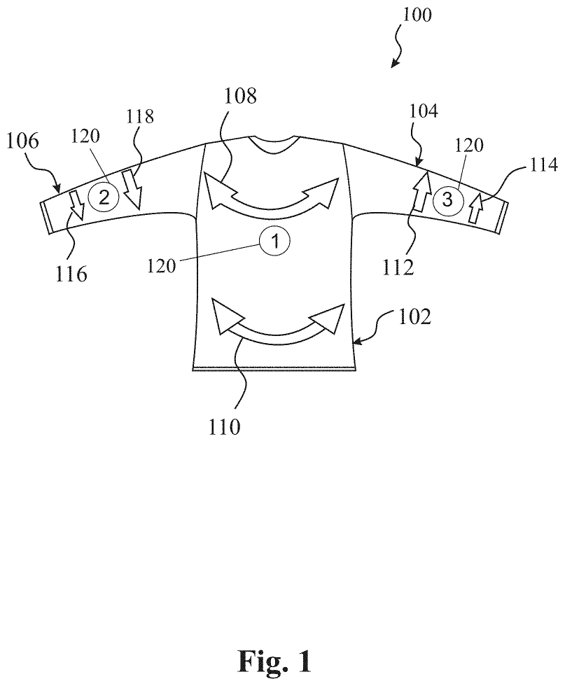

Now referring to FIG. 1, which shows the front view of an upper garment, according to an embodiment of the present invention. The upper garment 100 as shown in FIG. 1 is a long sleeve shirt having openings for neck and hands. The upper garment 100 is having a torso portion 102, upper left limb portion 104, and upper right limb portion 106. Several arrows can be seen disposed on the fabric of the garment. The arrow 108 is positioned over the chest segment of the body and is a dual head arrow. Then the arrow 110 is positioned below the arrow 108 and over the belly portion. On the limb portion, the left limb 104 can be seen having the two arrows 112 and 114, the arrow 112 is a single-head arrow and positioned near the elbow segment of the arm. The arrow 114 is positioned near the wrist segment of the arm. The arrow 114 is also single-headed. Like the left limb, the right limb 106 also has two single-headed arrows 116 and 118. The arrow 116 is positioned near the wrist and the arrow 118 is positioned near the elbow. The arrows 108 indicate a rotation of the shoulders and 110 indicate rotation of the waist, while other arrows on the arms indicate to move the arms up or down. FIG. 1 also show the number sequence 120 coupled with the direction indicia, arrow in case of FIG. 1. The number sequence 120 indicates the order in which the relative body segments should move.

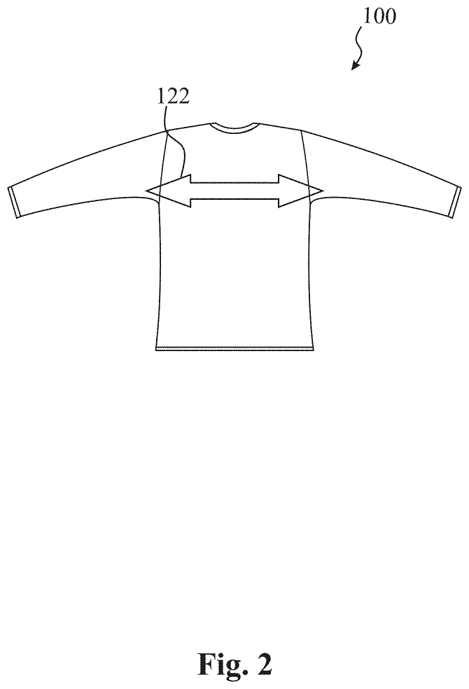

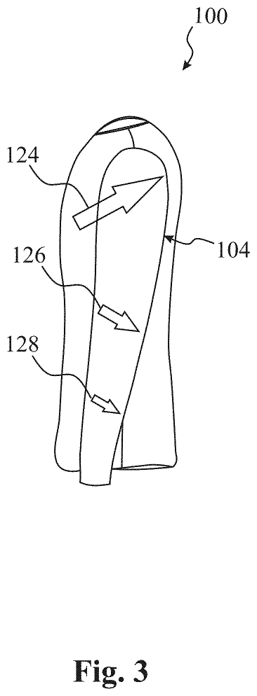

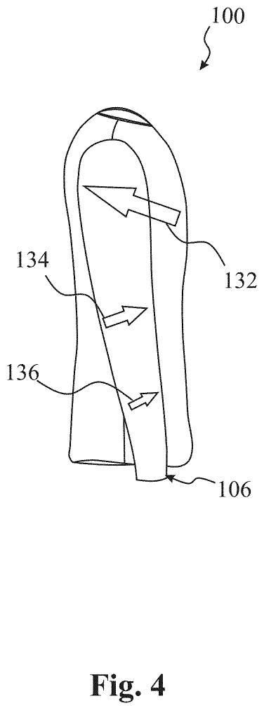

FIG. 2 is a rear view of the upper garment 100 and is shown to have a dual-headed arrow 122 on the upper portion. The dual-headed arrow 122 points towards the two shoulders and indicates the rotation or lateral movement of the shoulders. FIG. 3 is the left side of the upper garment 100 having three arrows 124, 126, and 128. The topmost arrow 124 points upwards and backward, while the lower arrows 126 and 128 points downwards and backward. FIG. 4 shows the right side of the upper garment 100 having three arrows 132, 134, and 136. The topmost arrow 132 backward and upward, while the lower two arrows 134 and 136 points downwards and forward.

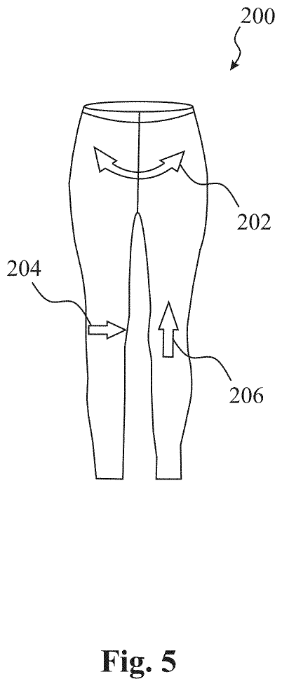

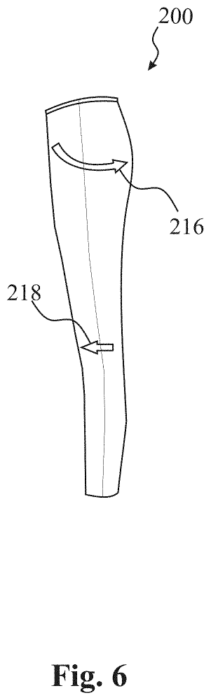

FIG. 5 is a front view of a lower garment 200 having three arrows 202, 204, and 206. The arrow 202 is a dual-headed arrow indicating for a rotational movement of the hips. The arrow 204 indicates the lateral movement for the right knee segment while arrow 206 indicates the upward movement of the left knee segment. FIG. 6 is the left side view of the lower garment having the two single-headed arrows 216 and 218. The arrow 216 positioned near the hips indicates the rotational movement of the hips. The other arrow 218, on the other hand, indicates a forward movement of the leg.

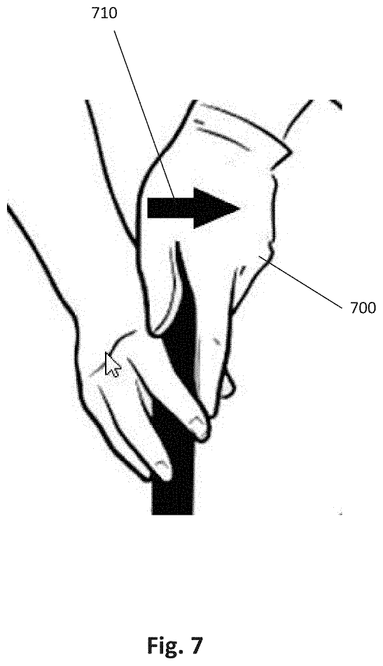

FIG. 7 is a front view of a glove 700 having one arrow 710. The arrow 710 is a single headed arrow positioned on the upper part of the hand above the thumb pointing to the left indicating a lateral movement of the hands.

As illustrated in FIG. 1-7 the arrangement of the arrows on a garment relative to the body segments, the direction of the arrows, and the number sequences, help a user to remember, by instantaneously visualizing and feeling the directional indicia, when incorporated with a textured material under the fabric, just before making a coordinated movement of a body segment or segments in a step or a series of steps of a task. For example, the user may know how a step or series of steps of a task has to be performed but just before or while performing the task, the user may forget one or more steps or movements of the body segments. The user may need a reminder of the movements or sequence of the movements. The present invention helps a user instantaneously visualize the movements and of the body segments in a step or a series of steps of a task. In another example, a golfer may be learning or have learned a technique of swinging the golf club, but due to the involvement of the coordinated movement of different body segments including the legs, hips, arms, hands, and, shoulders, it makes it difficult to remember all the body movements and the sequence they should happen. The golfer may remember the movement of the arms and shoulders but forget to rotate the hips. Moreover, the golfer may get confused between different coordinated movements and the alignment of the body segments. Thus, the present invention can help the golfer to visualize the steps of swinging the golf club as well as better position the body segments toward a target. Moreover, the arrangement of arrows can also help a user to recall a step from his memory. Also, the golfer could easily remember the steps by visualizing the arrows and number sequence incorporated on the garment immediately before performing the task, resulting in the building of the procedural memory of the task. It is to be understood that FIG. 1-7 shows a specific arrangement of arrows on a garment, the actual arrangement of the arrows on the garment depends upon the task, the step, or the series of the steps. In the case of a golf swing, the curved arrows on the garment can be positioned around the shoulders and hips as a reminder to turn body segments in a certain sequence. In the case of a tennis backhand, upward arrows incorporated on the inner arm segment of the garment can be a reminder to make the upward motion of the stroke. In the case of a basketball free throw, arrows can be placed on an arm sleeve close to the hand or on the hand to help in aiming the shot. Similarly, in various physical therapy exercises, arrows will be arranged on different body segments to indicate the desired movements of associated body segments. Moreover, the arrows can be placed anywhere relative to the body segment where the user wants to focus on a particular movement.

The arrows as shown in FIG. 1 are directional indicia which indicate the direction in which the associated body segment should be moved. For example, the arrow 114 positioned over the wrist segment and pointing in a direction away from the body indicates that the wrist segment should be moved in the direction of the arrow (i.e., away from the body). Similarly, the two-headed arrow 108 positioned over the chest area and pointing towards the shoulder indicate to rotate the shoulders. The arrows can be straight or curved. The shape of the tail of the arrow can also indicate the type of movement of the body segment. For example, the curved arrow may indicate a rotational movement of the associated body segment, while a straight arrow may indicate a lateral movement of the body segment in either direction of the arrow. The number sequence 120 indicates the order in which the body segments should move. For example, a rotation of the chest with number sequence “1” shall move first, followed by a downward movement of right arm marked “2”. An upward movement of the left arm marked with number sequence “3” shall move after the movement of the right arm.

The arrow shown in FIG. 7 is a directional indicia which indicates the direction in which the hand should be moved and aligned. For example, the arrow 302 positioned on the top part of the hand over the thumb, pointing in a direction towards a target that is on the left side of the body, indicates that the hand should be moved in that direction while aimed at a target.

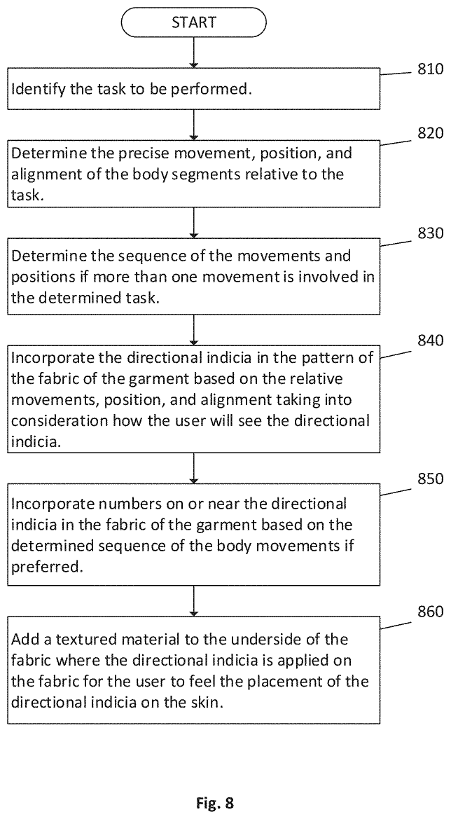

FIG. 8 shows a method of assisting a user to visualize and remember a coordinated movement of body segments. First, at step 810 is to identify the task to be performed. Particularly, a specific step or series of steps or a sequence of steps of the task. The task can be swinging a golf club, stroking a tennis racket, striking a cricket bat, shooting a basketball, throwing a bowling ball, lifting weights, different forms of exercise, physical therapy, or a dance routine. For example, one or multiple aspects of the golf swing can be implemented such as the back swing and/or the downswing. Once, the task is known, determine the precise body movements positions, and/or alignment required to accomplish the task, at step 820. The determination of the body movements includes analyzing the direction the body segments are moving, the position of the body segments at certain moments during the task, and the alignment of the body segments. For example, the critical body movements of the golf backswing and downswing can in part be determined to be a hip turn and shoulder turn either as separate tasks or together as one task. Further, after the body movements are determined, determine the sequence of the movements and positions if more than one movement is involved in the determined task, at step 830. Thereafter, based on the determined movements and positions of the body, identify the areas on the related body segments that can be depicted with an arrangement of directional indicia incorporated into the pattern of the fabric of the garment based on which direction the body segments need to move and how the user can visualize the directional indicia before and or during the movements, at step 840. Further, numbers can be placed either on or next to the directional indicia to indicate the sequence of the body movements, at step 850. Thereafter, to further aid the user in remembering the movements of a task, a textured material can be incorporated on the underside of the fabric where the directional indicia is applied for the user to feel the placement of the directional indicia on the skin at step 860. For example, in a golf swing, a curved doubled sided arrow extending from shoulder to shoulder across the chest depicts the rotational movement of the shoulders and will be incorporated in the fabric to depict that movement for the user to visualize and perform the swing. Additionally, a curved doubled sided arrow extending from hip to hip across the waist depicts the rotational movement of the hips and will be incorporated into the fabric to depict that movement for the user to visualize and perform. Further, the arrows across the shoulders can be labeled with a number “1” indicate the first move in the sequence of the golf swing and the hips can be labeled with a number “2” to indicate the second move in the golf swing. The user can look directly at the directional indicia immediately before or during the swing by either looking down at the directional indicia or looking up in a mirror. Citing another example, a single arrow over the hand pointing to the left and away from the body indicates a movement of the hands toward a target, such as in a putting stroke, and at the same time, the user can aim the hand at the hole in the putting green during the stroke.

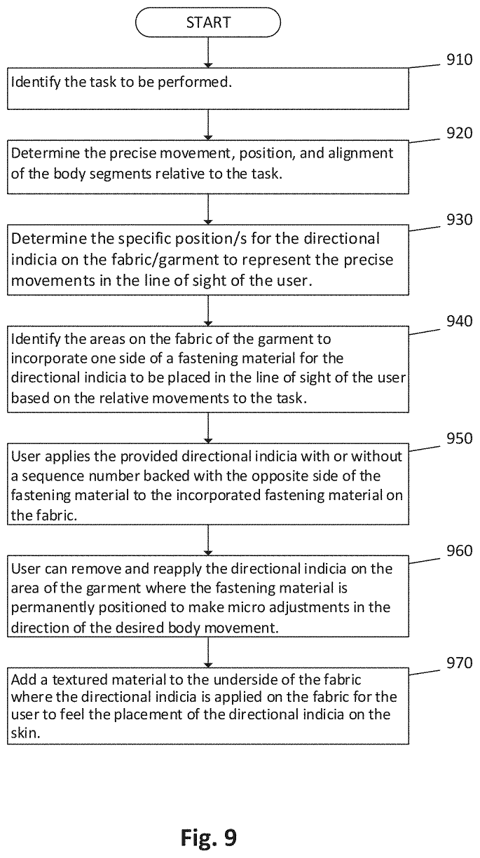

FIG. 9 is a flowchart further illustrating the method of incorporating directional indicia on a garment. First, identify the task to be performed, at step 910. Once, the task is known, determine the precise body movement, position, and the alignment of the body segments relative to the task, at step 920. Further, after the body movements are determined, determine the sequence of the movements and positions if more than one movement is involved in the determined task, at step 930. Further, based on the determined movements, identify the areas on the fabric to incorporate one side of a fastening material for the directional indicia to be placed in the line of sight of the user, at step 940. Thereafter, the user applies the provided directional indicia with or without a sequence number backed with the opposite side of the fastening material to the incorporated fastening material on the fabric of the garment, at step 950. Thereafter, the user can remove and reapply the directional indicia on the area of the garment where the fastening material is permanently positioned to make micro adjustments in the direction of the desired body movement, at step 960. Thereafter, to further aid the user in remembering the movements of a task, a textured material can be incorporated on the underside of the fabric where the directional indicia is applied for the user to feel the placement of the directional indicia on the skin, at step 970. For example, the user can adjust the position of the directional indicia to achieve a specific alignment of a body segment to a target relative to their body position.

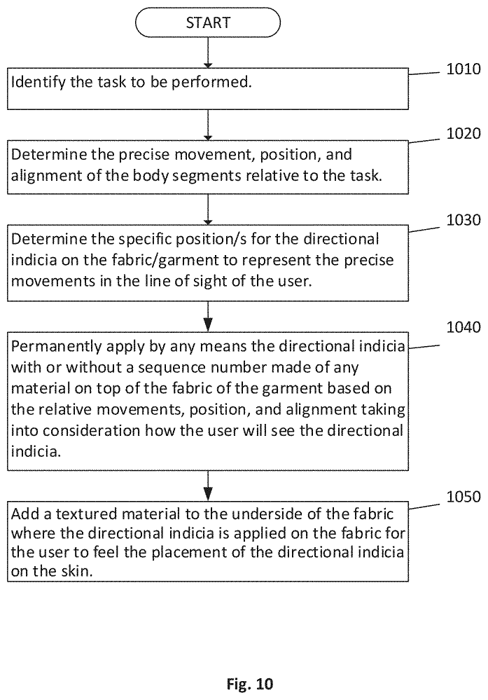

FIG. 10 is a flow chart further illustrating a method of incorporating directional indicia on a garment. First, identify the task to be performed, at step 1010. Once, the task is known, determine the precise movement position, and the alignment of the body segments relative to the task, at step 1020. Thereafter, based on the determined body movements, determine the sequence of the movements and positions if more than one movement is involved in the determined task, at step 1030. Thereafter, permanently apply by any means the directional indicia with or without a sequence number made of any material on top of the fabric of the garment based on the relative movements, position, and alignment taking into consideration how the user will see the directional indicia while performing the task. Thereafter, to further aid the user in remembering the movements of a task, a textured material can be incorporated on the underside of the fabric where the directional indicia is applied for the user to feel the placement of the directional indicia on the skin, at step 1050.

While the foregoing written description of the alternative embodiments of the invention enables one of ordinary skill to make and use what is considered presently to be the best mode thereof, those of ordinary skill will understand and appreciate the existence of variations, combinations, and equivalents of the specific embodiment, method, and examples herein. The alternative embodiments of the invention should therefore not be limited by the above-described embodiment, method, and examples, but by all embodiments and methods within the scope and spirit of the alternative embodiments invention as claimed.

1. An article comprising:
a garment; and
at least one directional indicia positioned on the garment relative to at least one body segment, wherein the position of the at least one directional indicia and a direction in which the at least one directional indicia points are configured to help a user in visualizing a task, wherein the task is a physical activity involving coordinated movement of the at least one body segment.

2. The article of claim 1, wherein the article further comprises a number sequence associated with the at least one directional indicia, wherein the at least one directional indicia points in a direction in which the relative at least body segment should move, and the number sequence indicates an order in which the relative at least one body segment should move.

3. The article of claim 1, wherein the at least one directional indicia is a single or double headed arrow.

4. The article of claim 2, wherein the at least one directional indicia is a double headed arrow and the number sequence is coupled to each head of the double headed arrow.

5. The article of claim 4, wherein the number sequence comprises a first number and a second number, the first number coupled to a first head of the double headed arrow, and the second number coupled to a second head of the double headed arrow, the first number is lower than the second number.

6. The article of claim 1, wherein the task comprises one or more steps in the physical activity, the physical activity is exercise, therapy, sports, or dance.

7. The article of claim 1, wherein the task comprises one or more steps involving coordinated movement of body segments, a plurality of directional indicia positioned on the garment relative to the body segments, wherein the plurality of directional indicia are arrows, and the arrows point in directions in which the relative body segments should move, a number sequence coupled to each of the plurality of directional indicia, the number sequence configured to indicate an order in which the relative body segments should be moving.

8. The article of claim 7, wherein the plurality of directional indicia comprises straight single-headed arrows, straight dual-headed arrows, curved single-headed arrows , and curved dual-headed arrows.

9. The article of claim 2, wherein the article comprises at least two directional indicia with the number sequence, the at least two directional indicia with the number sequence printed on the garment.

10. The article of claim 2, wherein the article comprises at least two directional indicia with the number sequence, the at least two directional indicia with the number sequence are removably coupled to the garment using hook and loop fasteners.

11. The article of claim 1, wherein the at least one directional indicia further comprises a textured backing configured to be felt on skin of the user wearing the garment, wherein sense of the textured backing aids the user to know where the at least one directional indicia points.

12. The article of claim 1, wherein the article further comprises at least one layer of textured material coupled to underside of the garment below the at least one directional indicia.

13. A method for visualizing and remembering a task, the method comprising:
providing a garment;
determining a task;
determining movement, position, and alignment of one or more body segments involved in performing the task, and the directions in which the one or more body segments should move and/or be aligned;
incorporating at least one directional indicia on the garment, wherein the at least one directional indicia is positioned on the garment relative to at least one of the one or more body segments, and wherein the at least one directional indicia points in a direction in which the at least one of the one or more body segments should move and/or be aligned.

14. The method of claim 13, wherein the method further comprises a step of:
donning the garment;
looking at the at least one directional indicia before making the movement or series of movements; and
aiming and/or moving the at least one of the one or more body segments in the direction in which the at least one directional indicia points.

15. The method of claim 14, wherein the method further comprises:
coupling a number sequence with at least two directional indicia;
looking at the at least two directional indicia with the number sequence before and/or during making the movements; and
moving the at least one of the one or more body segments in an order of the number sequence.

16. The method of claim 14, wherein the at least one directional indicia is a double headed arrow having a first head and an opposite second head, the method further comprises:
coupling a number sequence with each the first head and the second head;
looking at the double headed arrow with the number sequence before and/or during making the movements; and
moving the at least one of the one or more body segments in an order of the number sequence.

17. The method of claim 13, wherein the method further comprises:
incorporating at least one layer of textured material under fabric of the garment below the at least one direction indicia.

18. The method of claim 13, wherein the at least one directional indicia is a curved arrow, wherein degree of curvature of the arrow is proportional to angular movement of the at least one of the one or more body segments.
